(19) United States
(12) Patent Application Publication
(10) Pub. No.: US 2019/0281491 A1
(43) Pub. Date: Sep. 12, 2019

(54) QUALITY OF SERVICE (QOS) CONGESTION CONTROL HANDLING

(71) Applicant: QUALCOMM Incorporated, San Diego, CA (US)

(72) Inventors: Hong CHENG, Bridgewater, NJ (US); Sudhir Kumar BAGHEL, Hillsborough, NJ (US); Michaela VANDERVEEN, Tracy, CA (US); Zhibin WU, Sunnyvale, CA (US); Kapil GULATI, Dover, DE (US); Shailesh PATIL, San Diego, CA (US)

(21) Appl. No.: 16/273,061

(22) Filed: Feb. 11, 2019

Related U.S. Application Data
(60) Provisional application No. 62/641,936, filed on Mar. 12, 2018.

(51) Int. Cl. H04W 28/02; H04W 4/40; H04W 72/12

(52) U.S. Cl. CPC H04W 28/0268; H04W 28/0252; H04W 72/1236; H04W 4/40

(57) ABSTRACT

Aspects of the disclosure relate to a method of operating a scheduled entity for wireless communication. In some aspects, the scheduled entity determines to modify a first quality of service (QoS) level for a data transmission from the first device to a second device, wherein the first device is configured to communicate with the second device through a direct wireless communication link, and wherein the first QoS level is requested by an application of the first device. The scheduled entity modifies the first QoS level to a second QoS level, wherein the direct wireless communication link is able to support the second QoS level and is unable to support the first QoS level. The scheduled entity transmits the data transmission based on the second QoS level.

### PRIORITY CLAIM

This application claims priority to and the benefit of U.S. Provisional Application No. 62/641,936 filed in the U.S. Patent and Trademark Office on Mar. 12, 2018, the entire content of which is incorporated herein by reference as if fully set forth below in its entirety and for all applicable purposes.

### TECHNICAL FIELD

The technology discussed below relates generally to wireless communication systems, and more particularly, to quality of service (QoS) congestion control handling.

### INTRODUCTION

The existing quality of service (QoS) model for the LTE vehicle-to-everything (V2X) protocol is based on the device-to-device (D2D) proximity services per packet priority (PPPP) indicator, where a priority is indicated for each data packet by the application layer of a device (e.g., a UE, a vehicle). The PPPP indicator involves eight values and indicates the corresponding priority treatments of the packet across all applications. For example, an access stratum (AS) layer may use the eight values of the PPPP indicator to determine corresponding parameters and decide when to send out the packet. The PPPP indicator may be used to derive the delay requirement of a packet as well. Since more QoS parameters (e.g. reliability/error rate, delay) than those offered by the PPPP indicator are needed in handling new radio (NR) V2X applications, the PPPP indicator cannot meet the new requirements of the NR V2X applications. Therefore, a new QoS scheme including new parameters has been introduced to indicate the QoS requirements, such as a 5G QoS identifier (5QI), or parameters indicating specific bitrates, error rates, etc. For example, a 5QI value (e.g., “5QI 1” or “5QI 10”), may be applied to a flow level of V2X traffic and may map to parameters, such as resource type, priority level, packet delay budget, packet error rate and averaging window, etc.

However, there is a continuing need to improve QoS for NR V2X direct wireless communication links (e.g., the PC5 link).

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In accordance with some aspects of the disclosure, a method for a first device (e.g., a scheduled entity, such as a user equipment (UE)) is provided. The first device determines to modify a first quality of service (QoS) level for a data transmission from the first device to a second device, wherein the first device is configured to communicate with the second device through a direct wireless communication link, and wherein the first QoS level is requested by an application of the first device. The first device modifies the first QoS level to a second QoS level, wherein the direct wireless communication link is able to support the second QoS level and is unable to support the first QoS level, and transmits the data transmission based on the second QoS level.

In accordance with some aspects of the disclosure, an apparatus for wireless communication is provided. The apparatus includes a processor, a transceiver communicatively coupled to the at least one processor, and a memory communicatively coupled to the at least one processor. The processor is configured to determine, at the apparatus, to modify a first QoS level for a data transmission from the apparatus to a second apparatus, wherein the apparatus is configured to communicate with the second apparatus through a direct wireless communication link, and wherein the first QoS level is requested by an application of the apparatus. The processor is further configured to modify, at the apparatus, the first QoS level to a second QoS level, wherein the direct wireless communication link is able to support the second QoS level and is unable to support the first QoS level. The processor is further configured to transmit the data transmission based on the second QoS level.

In accordance with some aspects of the disclosure, an apparatus for wireless communication is provided. The apparatus includes means for determining, at the apparatus, to modify a first QoS level for a data transmission from the apparatus to a second apparatus, wherein the apparatus is configured to communicate with the second apparatus through a direct wireless communication link, and wherein the first QoS level is requested by an application of the apparatus. The apparatus further includes means for modifying, at the apparatus, the first QoS level to a second QoS level, wherein the direct wireless communication link is able to support the second QoS level and is unable to support the first QoS level, and means for transmitting the data transmission based on the second QoS level.

In accordance with some aspects of the disclosure, a non-transitory computer-readable medium storing computer-executable code is provided. The non-transitory computer-readable medium includes code for causing a computer to determine, at a first device, to modify a first QoS level for a data transmission from the first device to a second device, wherein the first device is configured to communicate with the second device through a direct wireless communication link, and wherein the first QoS level is requested by an application of the first device. The non-transitory computer-readable medium further includes code for causing a computer to modify, at the first device, the first QoS level to a second QoS level, wherein the direct wireless communication link is able to support the second QoS level and is unable to support the first QoS level. The non-transitory computer-readable medium further includes code for causing a computer to transmit the data transmission based on the second QoS level.

In accordance with some aspects of the disclosure, a method for a device (e.g., a scheduled entity, such as a UE) is provided. The device transmits a set of indications from a vehicle-to-everything (V2X) access stratum (AS) layer to a network, and obtains an indication from the network to modify a first QoS level for a data transmission from the device to a second device, wherein the device is configured to communicate with the second device through a direct wireless communication link, and wherein the direct wireless communication link is able to support a second QoS level and is unable to support the first QoS level. The device modifies the first QoS level to the second QoS level, and transmits the data transmission based on the second QoS level.

In accordance with some aspects of the disclosure, an apparatus for wireless communication is provided. The apparatus includes a processor, a transceiver communicatively coupled to the at least one processor, and a memory communicatively coupled to the at least one processor. The processor is configured to transmit, from the apparatus, a set of indications from a vehicle-to-everything (V2X) access stratum (AS) layer to a network, and obtain, at the apparatus, an indication from the network to modify a first QoS level for a data transmission from the apparatus to a second apparatus, wherein the first apparatus is configured to communicate with the second apparatus through a direct wireless communication link, and wherein the direct wireless communication link is able to support a second QoS level and is unable to support the first QoS level. The processor is further configured to modify, at the apparatus, the first QoS level to the second QoS level, and transmit the data transmission based on the second QoS level.

In accordance with some aspects of the disclosure, an apparatus for wireless communication is provided. The apparatus includes means for transmitting, from the apparatus, a set of indications from a vehicle-to-everything (V2X) access stratum (AS) layer to a network, means for obtaining, at the apparatus, an indication from the network to modify a first QoS level for a data transmission from the apparatus to a second apparatus, wherein the first apparatus is configured to communicate with the second apparatus through a direct wireless communication link, and wherein the direct wireless communication link is able to support a second QoS level and is unable to support the first QoS level, means for modifying, at the apparatus, the first QoS level to the second QoS level, and means for transmitting the data transmission based on the second QoS level.

In accordance with some aspects of the disclosure, a non-transitory computer-readable medium storing computer-executable code is provided. The non-transitory computer-readable medium includes code for causing a computer to transmit, from a device, a set of indications from a vehicle-to-everything (V2X) access stratum (AS) layer to a network. The non-transitory computer-readable medium further includes code for causing a computer to obtain, at the device, an indication from the network to modify a first quality of service (QoS) level for a data transmission from the device to a second device, wherein the device is configured to communicate with the second device through a direct wireless communication link, and wherein the direct wireless communication link is able to support a second QoS level and is unable to support the first QoS level. The non-transitory computer-readable medium further includes code for causing a computer to modify, at the device, the first QoS level to the second QoS level. The non-transitory computer-readable medium further includes code for causing a computer to transmit the data transmission based on the second QoS level.

### BRIEF DESCRIPTION OF THE DRAWINGS

FIG. 1 is a schematic illustration of a wireless communication system.

FIG. 2 is a conceptual illustration of an example of a radio access network.

FIG. 3 is a schematic illustration of an organization of wireless resources in an air interface utilizing orthogonal frequency divisional multiplexing (OFDM).

FIG. 4 is a block diagram conceptually illustrating an example of a hardware implementation for a scheduling entity according to some aspects of the disclosure.

FIG. 5 is a block diagram conceptually illustrating an example of a hardware implementation for a scheduled entity according to some aspects of the disclosure.

FIG. 6 illustrates an exemplary enhanced vehicle-to-everything (eV2X) protocol layer stack that may support the Quality of Service (QoS) model for the new radio (NR) vehicle-to-everything (V2X) protocol.

FIG. 7 is a flow chart illustrating an exemplary process according to some aspects of the disclosure.

FIG. 8 is a flow chart illustrating an exemplary process according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

The term new radio (NR) may generally refer to the new radio access technology (e.g., 5G technology) undergoing definition and standardization by 3GPP in Release 15 and beyond.

The term access stratum (AS) may generally refer to a functional grouping consisting of the parts in the radio access network and in the UE, and the protocols between these parts being specific to the access technique (i.e., the way the specific physical media between the UE and the radio access network is used to carry information).

The term ultra-reliable and low-latency communication (URLLC) (also referred to as mission-critical communication) will now be described. For example, the term reliability may refer to the probability of success of transmitting a given number of bytes within 1 ms under a given channel quality. The term ultra-reliable may refer to a high target reliability, e.g., a packet success rate greater than 99.999%. The term latency may refer to the time it takes to successfully deliver an application layer packet or message. The term low-latency may refer to a low target latency, e.g., 1 ms or even 0.5 ms (for comparison, a target for eMBB may be 4 ms). In the vehicle-to-everything (V2X) context, URLLC may also refer to a quality of service (QoS) level that is normally not met with legacy technology, e.g. latency below 20 ms, or packet success rate greater than 99%.

Device-to-device (D2D) (also referred to as point-to-point (P2P)) enables discovery of, and communication with nearby devices using a direct link between the devices (i.e., without passing through a base station, relay, or other node). D2D can enable mesh networks, and device-to-network relay functionality. Some examples of D2D technology include Bluetooth pairing, Wi-Fi Direct, Miracast, LTE-D, and an NR V2X direct wireless communication link (e.g., the PC5 link).

The term quality of service (QoS) may generally refer to the collective effect of service performances which determine the degree of satisfaction of a user of a service. QoS may be characterized by the combined aspects of performance factors applicable to all services, such as: service operability performance; service accessibility performance; service retainability performance; service integrity performance; and other factors specific to each service.

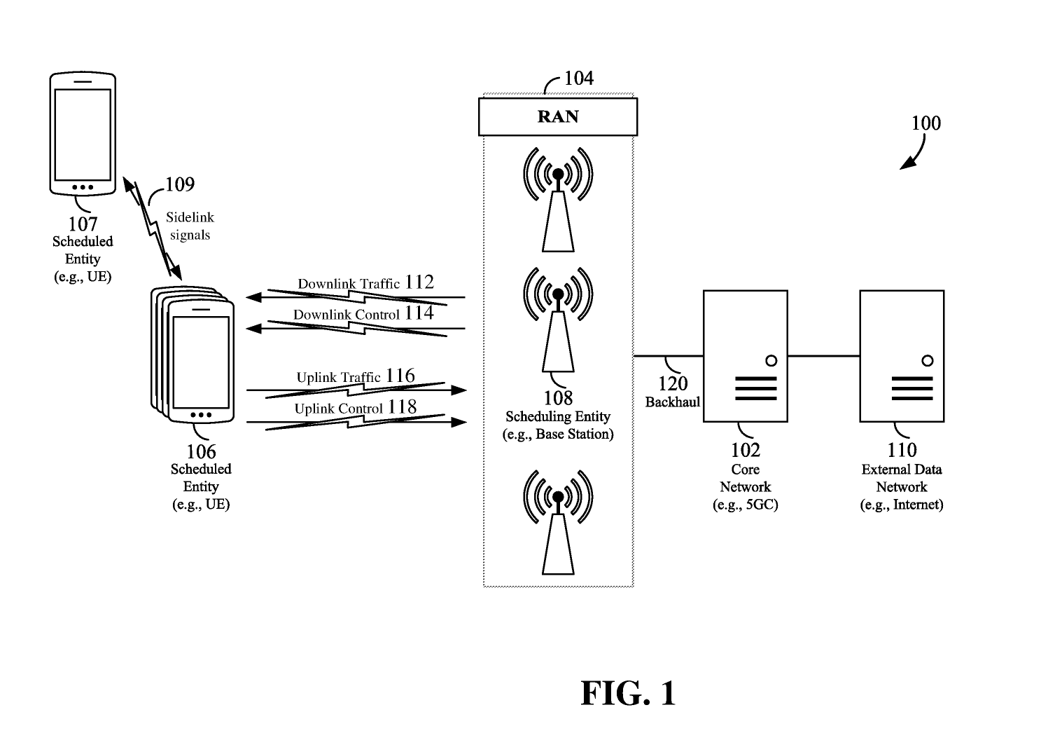

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104 and user equipments (UEs) 106 and 107. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In some examples, scheduled entities, such as the scheduled entity 106 and the scheduled entity 107, may utilize sidelink signals 109 for direct D2D communication. Sidelink signals may include sidelink traffic and sidelink control. Sidelink control information may in some examples include a request signal, such as a request-to-send (RTS), a source transmit signal (STS), and/or a direction selection signal (DSS). The request signal may provide for a scheduled entity 106 to request a duration of time to keep a sidelink channel available for a sidelink signal. Sidelink control information may further include a response signal, such as a clear-to-send (CTS) and/or a destination receive signal (DRS). The response signal may provide for the scheduled entity 106 to indicate the availability of the sidelink channel, e.g., for a requested duration of time. An exchange of request and response signals (e.g., handshake) may enable different scheduled entities performing sidelink communications to negotiate the availability of the sidelink channel prior to communication of the sidelink traffic information.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

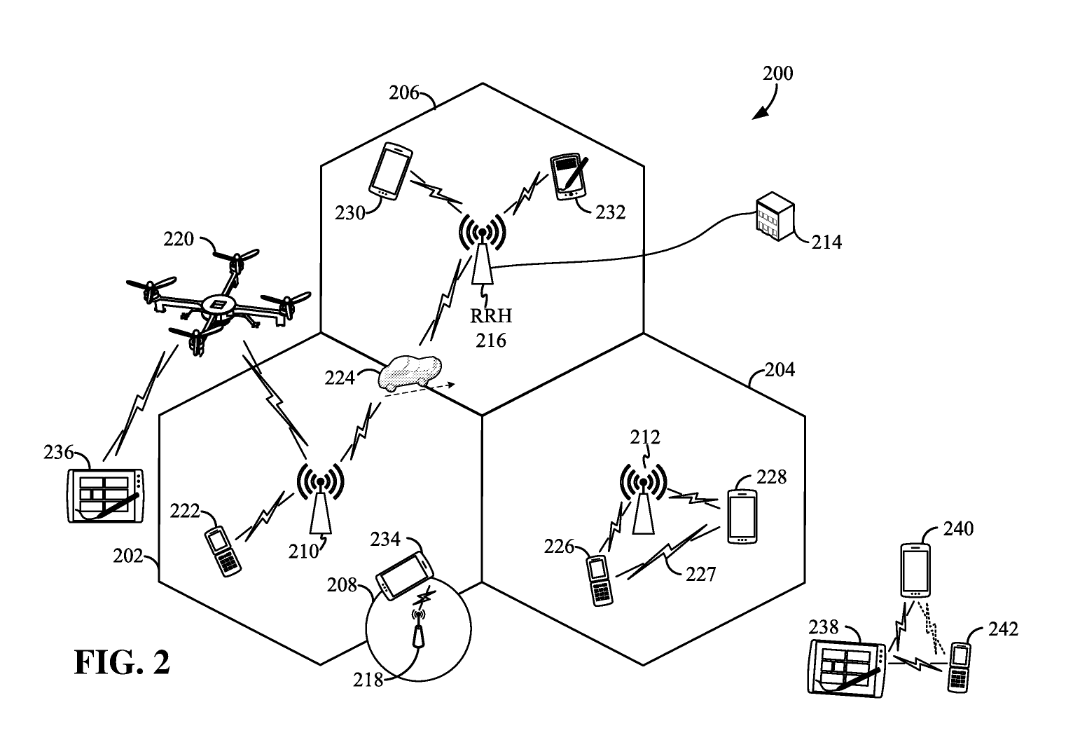

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In the radio access network 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

In various aspects of the disclosure, a radio access network 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

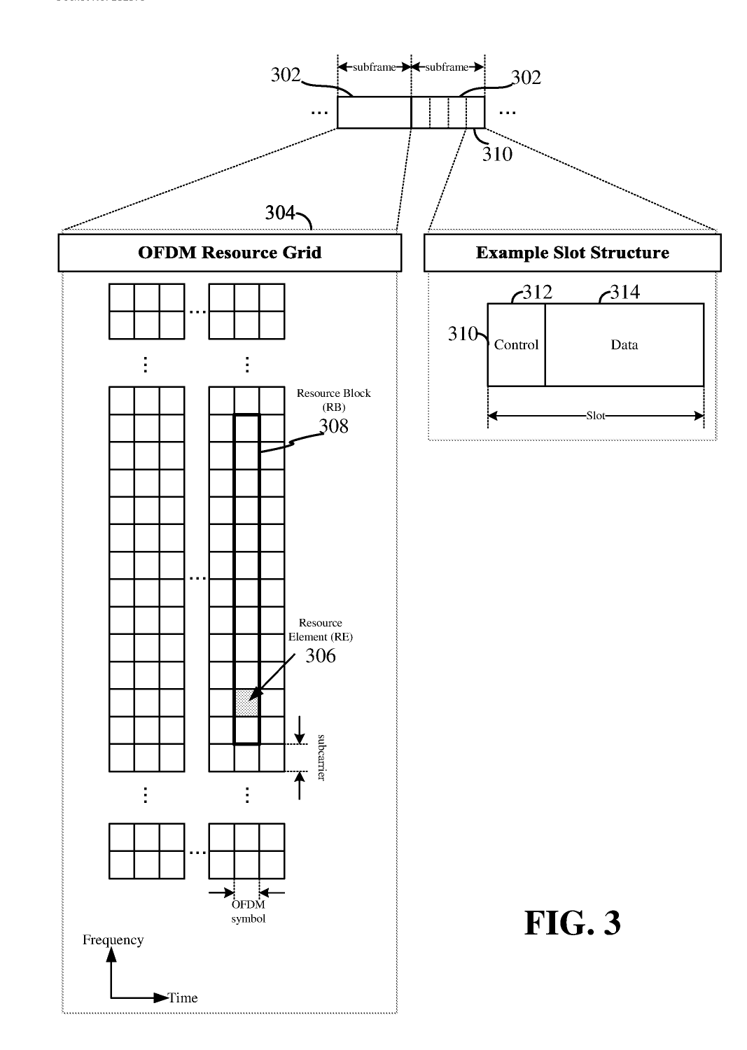

Various aspects of the present disclosure will be described with reference to an OFDM waveform, schematically illustrated in FIG. 3. It should be understood by those of ordinary skill in the art that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

Within the present disclosure, a frame refers to a duration of 10 ms for wireless transmissions, with each frame consisting of 10 subframes of 1 ms each. On a given carrier, there may be one set of frames in the UL, and another set of frames in the DL. Referring now to FIG. 3, an expanded view of an exemplary DL subframe 302 is illustrated, showing an OFDM resource grid 304. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 304 may be used to schematically represent time-frequency resources for a given antenna port. That is, in a multiple-input multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A UE generally utilizes only a subset of the resource grid 304. An RB may be the smallest unit of resources that can be allocated to a UE. Thus, the more RBs scheduled for a UE, and the higher the modulation scheme chosen for the air interface, the higher the data rate for the UE.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each subframe 302 (e.g. a 1 ms subframe) may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs.

An expanded view of one of the slots 310 illustrates the slot 310 including a control region 312 and a data region 314. In general, the control region 312 may carry control channels (e.g., PDCCH), and the data region 314 may carry data channels (e.g., PDSCH or PUSCH). Of course, a slot may contain all DL, all UL, or at least one DL portion and at least one UL portion. The simple structure illustrated in FIG. 3 is merely exemplary in nature, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals, including but not limited to a demodulation reference signal (DMRS) a control reference signal (CRS), or a sounding reference signal (SRS). These pilots or reference signals may provide for a receiving device to perform channel estimation of the corresponding channel, which may enable coherent demodulation/detection of the control and/or data channels within the RB 308.

In a DL transmission, the transmitting device (e.g., the scheduling entity 108) may allocate one or more REs 306 (e.g., within a control region 312) to carry DL control information 114 including one or more DL control channels that generally carry information originating from higher layers, such as a physical broadcast channel (PBCH), a physical downlink control channel (PDCCH), etc., to one or more scheduled entities 106. In addition, DL REs may be allocated to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

The synchronization signals PSS and SSS (collectively referred to as SS), and in some examples, the PBCH, may be transmitted in an SS block that includes 4 consecutive OFDM symbols, numbered via a time index in increasing order from 0 to 3. In the frequency domain, the SS block may extend over 240 contiguous subcarriers, with the subcarriers being numbered via a frequency index in increasing order from 0 to 239. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity 106) may utilize one or more REs 306 to carry UL control information 118 (UCI). The UCI can originate from higher layers via one or more UL control channels, such as a physical uplink control channel (PUCCH), a physical random access channel (PRACH), etc., to the scheduling entity 108. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the scheduling entity 108 to schedule uplink transmissions. Here, in response to the SR transmitted on the control channel 118, the scheduling entity 108 may transmit downlink control information 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In addition to control information, one or more REs 306 (e.g., within the data region 314) may be allocated for user data or traffic data. Such traffic may be carried on one or more traffic channels, such as, for a DL transmission, a physical downlink shared channel (PDSCH); or for an UL transmission, a physical uplink shared channel (PUSCH).

In order for a UE to gain initial access to a cell, the RAN may provide system information (SI) characterizing the cell. This system information may be provided utilizing minimum system information (MSI), and other system information (OSI). The MSI may be periodically broadcast over the cell to provide the most basic information required for initial cell access, and for acquiring any OSI that may be broadcast periodically or sent on-demand. In some examples, the MSI may be provided over two different downlink channels. For example, the PBCH may carry a master information block (MIB), and the PDSCH may carry a system information block type 1 (SIB1). In the art, SIB1 may be referred to as the remaining minimum system information (RMSI).

OSI may include any SI that is not broadcast in the MSI. In some examples, the PDSCH may carry a plurality of SIBs, not limited to SIB1, discussed above. Here, the OSI may be provided in these SIBs, e.g., SIB2 and above.

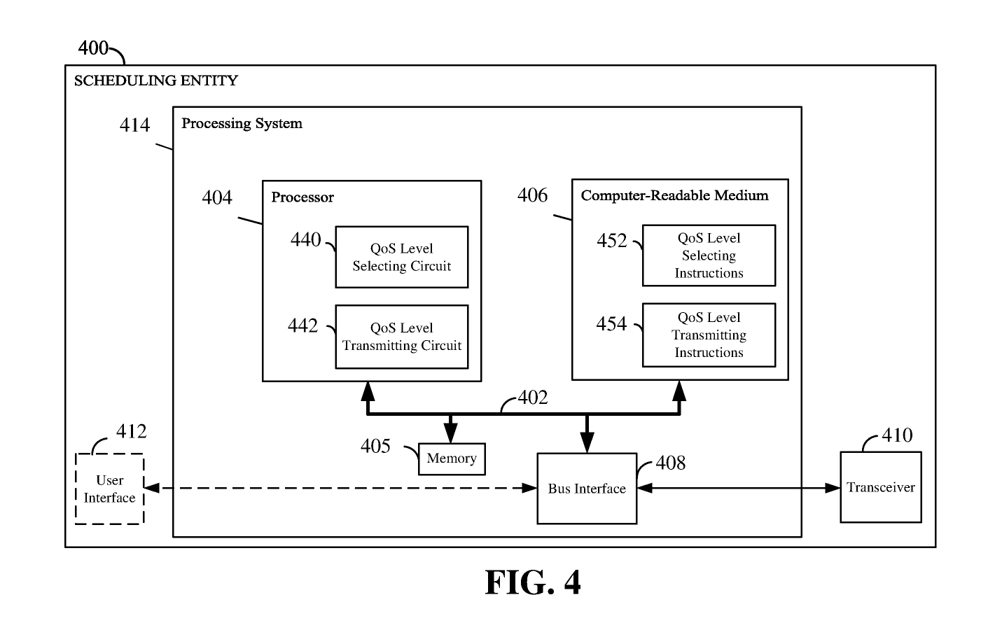

The channels or carriers described above and illustrated in FIGS. 1 and 4 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

FIG. 4 is a block diagram illustrating an example of a hardware implementation for a scheduling entity 400 employing a processing system 414. For example, the scheduling entity 400 may be a base station as illustrated in any one or more of FIGS. 1 and/or 2.

The scheduling entity 400 may be implemented with a processing system 414 that includes one or more processors 404. Examples of processors 404 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 400 may be configured to perform any one or more of the functions described herein.

In this example, the processing system 414 may be implemented with a bus architecture, represented generally by the bus 402. The bus 402 may include any number of interconnecting buses and bridges depending on the specific application of the processing system 414 and the overall design constraints. The bus 402 communicatively couples together various circuits including one or more processors (represented generally by the processor 404), a memory 405, and computer-readable media (represented generally by the computer-readable medium 406). The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a communication interface or means for communicating with various other apparatus over a transmission medium. Depending upon the nature of the apparatus, a user interface 412 (e.g., keypad, display, speaker, microphone, joystick) may also be provided. Of course, such a user interface 412 is optional, and may be omitted in some examples, such as a base station.

In some aspects of the disclosure, the processor 404 may include QoS level selecting circuitry 440 configured for various functions, including, for example, selecting a QoS level for a scheduled entity that is within a range of QoS levels provided by the scheduled entity.

In some aspects of the disclosure, the processor 404 may include QoS level transmitting circuitry 442 configured for various functions, including, for example, transmitting a selected QoS level to a scheduled entity. For example, the QoS level transmitting circuitry 442 may transmit the selected QoS level to the scheduled entity to change the QoS level requested by an application of the scheduled entity to another QoS level (e.g., the selected QoS level) that is within a range of QoS levels provided by the scheduled entity.

The processor 404 is responsible for managing the bus 402 and general processing, including the execution of software stored on the computer-readable medium 406. The software, when executed by the processor 404, causes the processing system 414 to perform the various functions described below for any particular apparatus. The computer-readable medium 406 and the memory 405 may also be used for storing data that is manipulated by the processor 404 when executing software.

One or more processors 404 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 406. The computer-readable medium 406 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 406 may reside in the processing system 414, external to the processing system 414, or distributed across multiple entities including the processing system 414. The computer-readable medium 406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the computer-readable storage medium 406 may include QoS level selecting software 452 configured for various functions, including, for example, selecting a QoS level for a scheduled entity that is within a range of QoS levels provided by the scheduled entity.

In some aspects of the disclosure, the computer-readable storage medium 406 may include QoS level transmitting software 454 configured for various functions, including, for example, transmitting a selected QoS level to a scheduled entity.

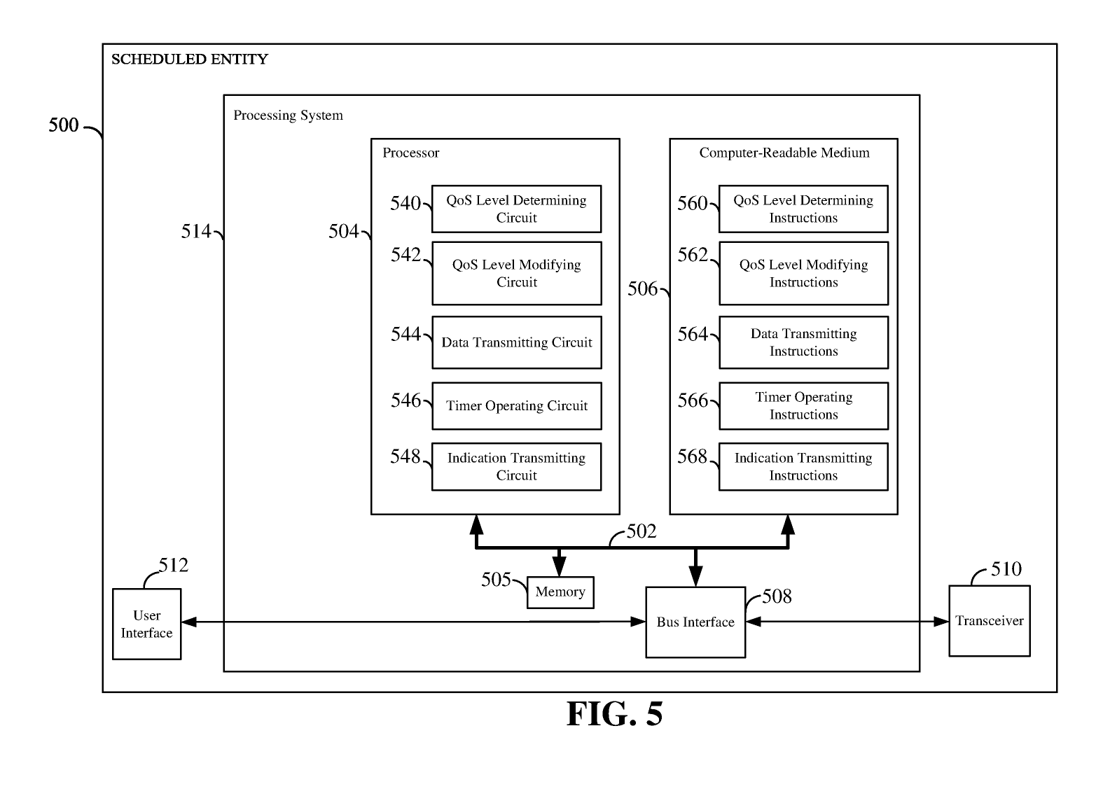

FIG. 5 is a conceptual diagram illustrating an example of a hardware implementation for an exemplary scheduled entity 500 employing a processing system 514. In accordance with various aspects of the disclosure, an element, or any portion of an element, or any combination of elements may be implemented with a processing system 514 that includes one or more processors 504. For example, the scheduled entity 500 may be a user equipment (UE) as illustrated in any one or more of FIGS. 1 and/or 2. In some implementations, the scheduled entity 500 may be a vehicle.

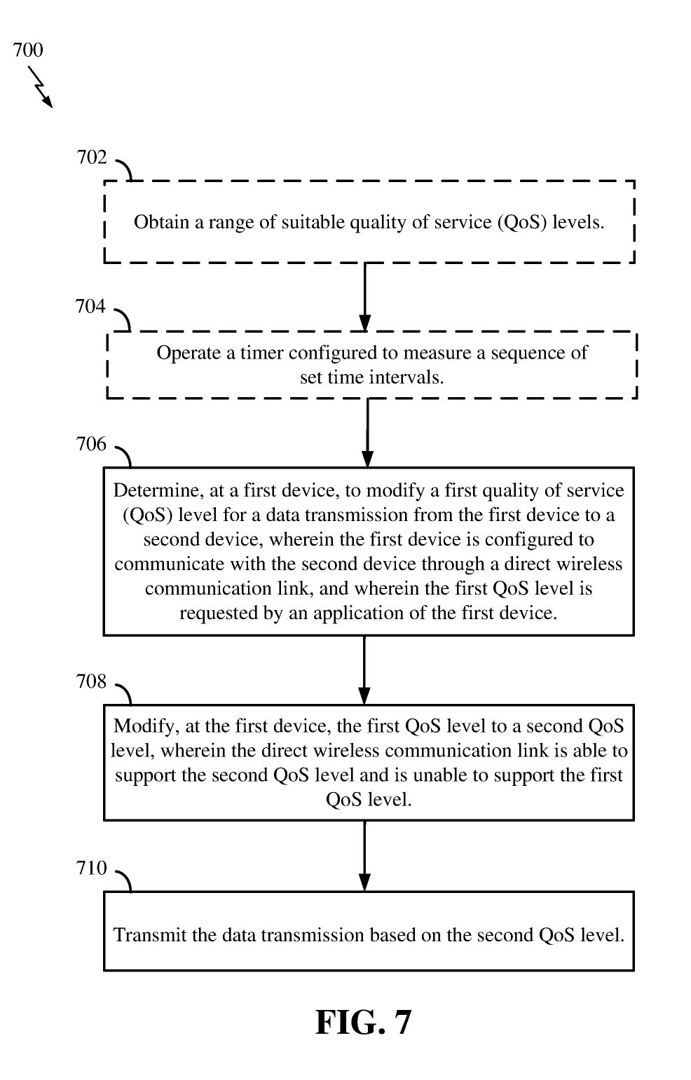

The processing system 514 may be substantially the same as the processing system 414 illustrated in FIG. 4, including a bus interface 508, a bus 502, memory 505, a processor 504, and a computer-readable medium 506. Furthermore, the scheduled entity 500 may include a user interface 512 and a transceiver 510 substantially similar to those described above in FIG. 4. That is, the processor 504, as utilized in a scheduled entity 500, may be used to implement any one or more of the processes described below and illustrated in FIGS. 7 and/or 8.

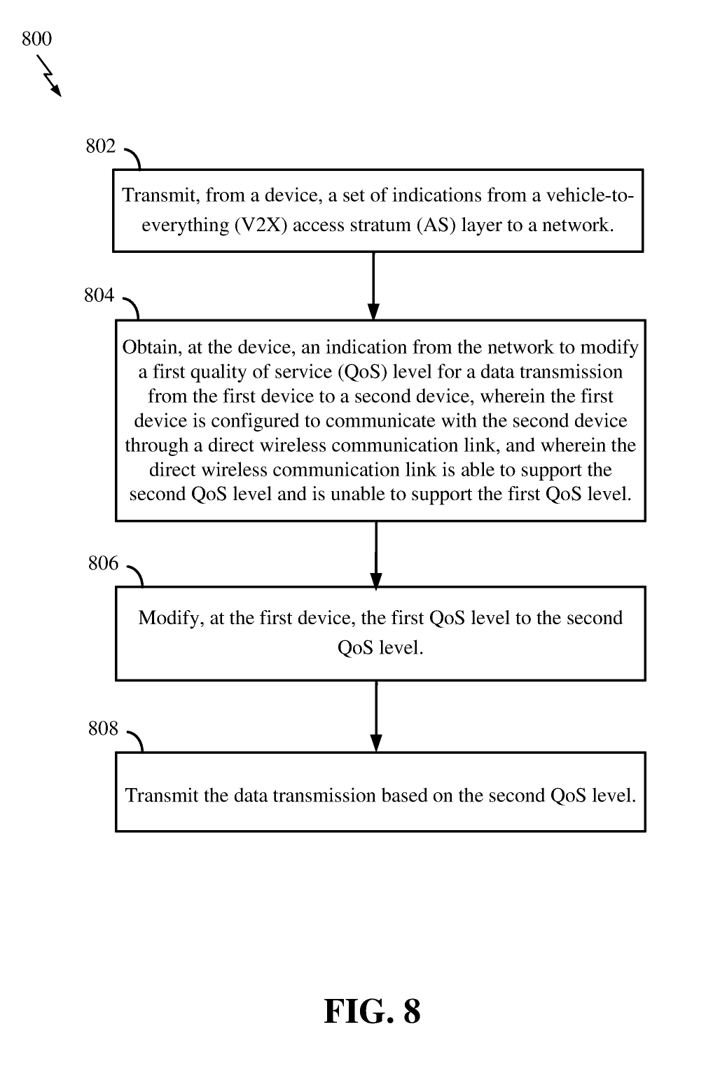

In some aspects of the disclosure, the processor 504 may include QoS level determining circuitry 540 configured for various functions, including, for example, determining to modify a first QoS level for a data transmission from the scheduled entity 500 (also referred to as a first scheduled entity or a first device) to a second scheduled entity (also referred to as a second device), obtaining a range of suitable QoS levels from one or more sources, and/or obtaining an indication from the network to modify a first QoS level for a data transmission from the scheduled entity 500 to the second scheduled entity. For example, the scheduled entity 500 may be configured to communicate with the second scheduled entity through a direct wireless communication link (e.g., a PC5 link), and the first QoS level may be requested by an application of the scheduled entity 500. For example, the QoS level determining circuitry 540 may be configured to implement one or more of the functions described below in relation to FIGS. 7 and 8, including, e.g., blocks 702, 706, 804.

In some aspects of the disclosure, the processor 504 may include QoS level modifying circuitry 542 configured for various functions, including, for example, modifying the first QoS level to a second QoS level. For example, the QoS level modifying circuitry 542 may be configured to implement one or more of the functions described below in relation to FIGS. 7 and 8, including, e.g., blocks 708, 806.

In some aspects of the disclosure, the processor 504 may include data transmitting circuitry 544 configured for various functions, including, for example, transmitting the data transmission based on the second QoS level. For example, the data transmitting circuitry 544 may be configured to implement one or more of the functions described below in relation to FIGS. 7 and 8, including, e.g., blocks 710, 808.

In some aspects of the disclosure, the processor 504 may include timer operating circuitry 546 configured for various functions, including, for example, operating a timer configured to measure a sequence of set time intervals. For example, the timer operating circuitry 546 may be configured to implement one or more of the functions described below in relation to FIG. 7, including, e.g., block 704.

In some aspects of the disclosure, the processor 504 may include indication transmitting circuitry 548 configured for various functions, including, for example, transmitting a set of indications from a vehicle-to-everything (V2X) access stratum (AS) layer to a network. For example, the indication transmitting circuitry 548 may be configured to implement one or more of the functions described below in relation to FIG. 8, including, e.g., block 802.

### Vehicle-to-Everything (V2X) Communications

V2X communications may involve communications through a direct link, such as a PC5 link, established between two scheduled entities (e.g., between two UEs, or between two vehicles) using a pre-allocated spectrum. The PC5 link may be a direct connection between scheduled entities based on a PC5 interface and/or protocols. For example, and as described in detail herein, a scheduled entity (e.g., the scheduled entity 500) may communicate directly with another scheduled entity over the PC5 link based on new radio (NR) protocols (e.g., 5G protocols) by implementing protocol layers configured to support the NR protocols, such as an NR MAC layer, NR PHY layer, and/or other suitable protocol layers. In some examples, the scheduled entity may also communicate directly with another scheduled entity over the PC5 link based on legacy protocols (e.g., LTE protocols) by implementing protocol layers configured to support the legacy protocols, such as an LTE MAC layer (also referred to herein as a MAC layer), LTE PHY layer (also referred to herein as a PHY layer), and/or other suitable protocol layers.

With respect to communications over the PC5 link using NR protocols, since the pre-allocated spectrum for the PC5 link will typically have limited resources, congestion (e.g., a reduction in throughput) will likely occur in the PC5 links in scenarios where too many scheduled entities attempt to communicate in close proximity. The aspects disclosed herein may reduce and/or avoid such congestion in the direct links

### Protocol Layers for V2X Communications

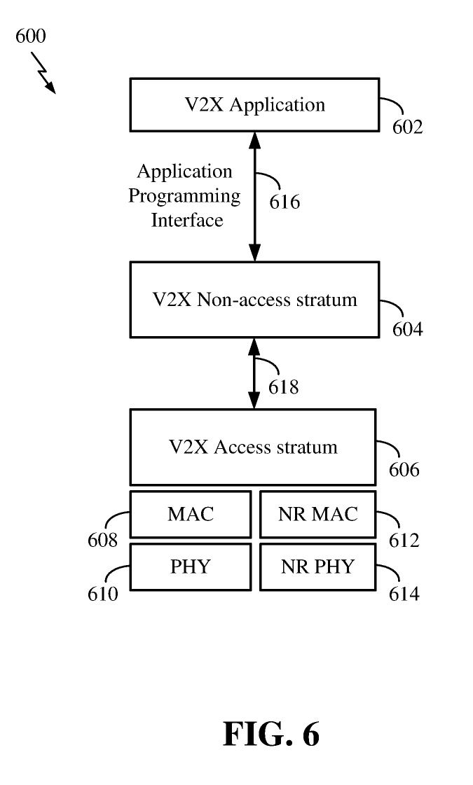

FIG. 6 illustrates an exemplary enhanced vehicle-to-everything (eV2X) protocol layer stack 600 according to some aspects of the disclosure. The eV2X protocol layer stack 600 may be implemented at a scheduled entity (e.g., the scheduled entity 500) to enable communications with at least one other scheduled entity over a direct link (e.g., the PC5 link). As shown in FIG. 6, the eV2X protocol layer stack 600 may include a V2X application layer 602, a V2X non-access stratum (NAS) layer 604, a V2X access stratum (AS) layer 606, a medium access control (MAC) layer 608, a physical (PHY) layer 610, a new radio (NR) MAC layer 612, and a new radio (NR) PHY layer 614. Each protocol layer of the eV2X protocol layer stack 600 may represent one or more functions or services, and may be implemented as hardware, software, or a combination thereof.

For example, the MAC layer 608 and the PHY layer 610 may support communications over the PC5 link using legacy protocols (e.g., LTE protocols), and the NR MAC layer 612 and the NR PHY layer 614 may support communications over a PC5 link using NR protocols (e.g., 5G protocols). In some examples, the eV2x protocol layer stack 600 may support a Quality of Service (QoS) model for the new radio (NR) vehicle-to-everything (V2X) protocol. In other examples, the eV2X protocol layer stack 600 may support both the QoS model for the NR V2X protocol and a QoS model for the legacy LTE V2X protocol.

As shown in FIG. 6, the V2X application layer 602 may communicate with the V2X NAS layer 604 through the application programming interface (API) 616. As further shown in FIG. 6, the V2X NAS layer 604 may communicate with V2X AS layer 606 through the interface 618.

The V2X application layer 602 may include one or more applications (e.g., a media streaming application) that may operate on the scheduled entity (e.g., the scheduled entity 500). In some scenarios, the V2X application layer 602 may indicate (e.g., to the V2X AS layer 606) a QoS level that should be met in order to achieve a level of performance intended by the designers of the application. For example, the V2X application layer 602 may indicate a QoS level for a V2X communication stream associated with a V2X application. The aspects described herein may enable the V2X NAS layer 604 to modify (e.g., appropriately increase or decrease) the QoS level indicated by the V2X application layer 602 for a V2X communication stream to be transmitted over a PC5 link using NR protocols. For example, the V2X NAS layer 604 may modify the QoS level based on a configuration of one or more QoS requirements and/or one or more items of information from the V2X AS layer 606. Therefore, in situations where the QoS level indicated by the V2X application layer 602 cannot be met (e.g., due to congestion in a PC5 link), such modification of the QoS level may prevent termination of the application and, thereby, improve the user experience.

In some aspects of the disclosure, the V2X NAS layer 604 may obtain a range of suitable QoS levels that may be used for modifying the QoS level requested (also referred to herein as the requested QoS level) by the V2X application layer 602. For example, the V2X NAS layer 604 may obtain the range of suitable QoS levels from one or more sources, such as an application running on the scheduled entity and/or a network control function of the network. In some examples described herein, the range of suitable QoS levels may be expressed as a set of upper and lower QoS level bounds (e.g., a maximum QoS level and a minimum QoS level), a set or list of QoS levels, and/or a sequence of QoS levels (e.g., a number of different QoS levels arranged in increasing or decreasing order). In some aspects of the disclosure, the application itself may provide an indication of a range of QoS levels to facilitate modification of the requested QoS level. In some aspects of the disclosure, the V2X NAS layer 604 may obtain QoS level mapping information from the network and/or via provisioning (e.g., via Open Mobile Alliance (OMA) Device Management (OMA DM) as a configuration parameter, or via a policy control function (PCF) as part of UE policies). In such examples, the V2X NAS layer 604 may use the QoS level mapping information to modify the requested QoS level.

The V2X AS layer 606 may provide a corresponding set of indications for the V2X NAS layer 604. The set of indications may be either requested by V2X NAS layer 604 or may be a standardized set of indications that may be combined and interpreted by the V2X NAS layer 604.

In some aspects of the disclosure, the V2X NAS layer 604 may implement a timer when determining whether or not to modify the requested QoS level and/or when determining how to modify the requested QoS level (e.g., when determining an updated QoS level to be used instead of the requested QoS level). In one aspect of the disclosure, the V2X NAS layer 604 may implement a QoS level map that facilitates modification of the requested QoS level. The V2X NAS layer 604 may reevaluate the QoS level map at predetermined time intervals. For example, during a first time interval, the V2X NAS layer 604 may implement a first QoS level map. If the QoS level requested by the V2X application layer 602 is QoS level 1, the first QoS level map may indicate that QoS level 1 should be mapped to QoS level 2. Accordingly, the V2X NAS layer 604 may modify the requested QoS level (e.g., QoS level 1) to QoS level 2 during the first time interval. During a second time interval, the V2X NAS layer 604 may implement a second QoS level map. If the QoS level requested by the V2X application layer 602 is QoS level 1, the second QoS level map may indicate that QoS level 1 should be mapped to QoS level 3. Accordingly, in this example, the V2X NAS layer 604 may modify the requested QoS level (e.g., QoS level 1) to QoS level 3 during the second time interval. In the examples above, QoS level 1 may have higher requirements than QoS level 2, and QoS level 2 may have higher requirements than QoS level 3. Therefore, modification of QoS level 1 to either QoS level 2 or QoS level 3 may be considered a downgrade of the QoS. It can be appreciated that the use of the timer may help to control the frequency of QoS level map reevaluations that may be performed by the V2X NAS layer 604, thereby enabling control over how quickly the V2X NAS layer 604 may address changing congestion levels in a PC5 link and control over the consumption of resources (e.g., processor bandwidth, battery power, etc.) experienced as a result of the QoS level map reevaluations.

In some aspects of the disclosure, the V2X NAS layer 604 may implement a sequence of QoS levels, such as a 5QI sequence as described herein, when determining how to modify the requested QoS level (e.g., when determining an updated QoS level to be used instead of the QoS level requested by an application). An example 5QI sequence may be indicated as: 5QI 10→5QI 3→5QI 1. For example, 5QI 10 may indicate (among other things) a packet delay budget (PDB) of 5 ms, 5QI 3 may indicate (among other things) a PDB of 50 ms, and 5QI 1 may indicate (among other things) a PDB of 100 ms. In some aspects of the disclosure, the V2X NAS layer 604 may obtain a 5QI sequence from the V2X application layer 602, or from the network via signaling and/or provisioning.

For example, if the V2X NAS layer 604 is configured to implement the example 5QI sequence described above (e.g., 5QI 10→5QI 3→5QI 1), the V2X NAS layer 604 may determine whether the QoS level requested by the V2X application layer 602 may be met. In this example, if the QoS level requested by the V2X application layer 602 is 5QI 10 and the PC5 link is unable to support that QoS level, the V2X NAS layer 604 may modify (e.g., decrease or downgrade) the requested QoS level from 5QI 10 to 5QI 3 according to the example 5QI sequence. For example, the PC5 link may be unable to support the requested QoS level due to congestion (e.g., a reduction in throughput) in the PC5 link. The congestion may occur in the PC5 link, for example, if too many scheduled entities in close proximity attempt to communicate on resources allocated for the PC5 link and/or if radio conditions are poor. If the V2X NAS layer 604 then determines that the PC5 link is also unable to support the QoS level 5QI 3, the V2X NAS layer 604 may modify (e.g., decrease or downgrade) the QoS level from 5QI 3 to 5QI 1 according to the example 5QI sequence. Therefore, by implementing a 5QI sequence as described above, the V2X NAS layer 604 may gradually relax (e.g., increase or decrease) one or more QoS parameters (e.g., packet delay budget requirements) to allow an application to run on the scheduled entity during times when network conditions (e.g., congestion in a PC5 link) prevent the QoS level requested by application to be met. In one example, the QoS level (e.g., a 5QI value) requested by an application as described herein may include several QoS parameters, such as a PDB value and/or a reliability value. Therefore, when the QoS level is modified (e.g., downgraded to a next lower QoS level), one or more of the several QoS parameters (e.g., the reliability value) may be reduced. For example, the reliability value may be reduced from five nines (e.g., 99.999%) to four nines (e.g., 99.99%).

In some aspects of the disclosure, a 5QI sequence may be specified by the V2X application layer 602 (e.g., as a wrench) and provided to the V2X NAS layer 604. The V2X NAS layer 604 may then freely modify the QoS level requested by an application according to the knowledge of the V2X NAS layer 604 of the direct communication link conditions. Therefore, instead of applying a fixed 5QI sequence (e.g., 5QI 10→5QI 3→5QI 1), the V2X NAS layer 604 may be allowed to modify the QoS level based on the current operation mode. In some aspects of the disclosure, the V2X NAS layer 604 may obtain a range of 5QI values or a list of the 5QI values from the V2X application layer 602 or from the network via signaling (e.g., control plane signaling over RRC) or via provisioning (e.g., via OMA DM as a configuration parameter, or via a PCF as part of UE policies).

It should be noted that the previously described 5QI sequence may skip one or more available 5QIs to enable the V2X NAS layer 604 to efficiently identify another (e.g., downgraded) 5QI that has a higher likelihood of being supported by the PC5 link. Therefore, with reference to the previously discussed example, the 5QI sequence 5QI 10→5QI 3→5QI 1 may enable the V2X NAS layer 604 to skip the QoS levels 5QI 9, 5QI 8, 5QI 7, 5QI 6, 5QI 5 and 5QI 4 when downgrading from 5QI 10 to 5QI 3. In this example, a QoS parameter (e.g., the packet delay bound) that needs to be relaxed to enable operation of an application may be configured with similar values in QoS levels 5QI 9, 5QI 8, 5QI 7, 5QI 6, 5QI 5 and 5QI 4. As such, the V2X NAS layer 604 may avoid attempting QoS levels (e.g., 5QI 9, 5QI 8, 5QI 7, 5QI 6, 5QI 5 and/or 5QI 4) that are not likely to be effective.

In some aspects of the disclosure, the V2X NAS layer 604 may modify (e.g., upgrade or downgrade) a QoS level requested by an application of the V2X application layer 602 based on a set of indications from the V2X AS layer 606. In other aspects of the disclosure, the V2X NAS layer 604 may modify (e.g., upgrade or downgrade) a QoS level requested by an application of the V2X application layer 602 based on an indication from the V2X AS layer 606, an optional range of QoS levels from the application, and/or a configuration (e.g., Provider Service Identifier (PSID) to 5QI mapping ladder) of the scheduled entity. The PSID may also be referred to as an Intelligent Transportation Systems Application Object Identifier (ITS-AID). In other aspects of the disclosure, the V2X NAS layer 604 may provide a range of QoS levels to the V2X AS layer 606 for some freedom in adjustments at the V2X AS layer 606. For example, a PSID/ITS-AID to 5QI mapping ladder may allow each application at the scheduled entity to have its own 5QI mapping (e.g., a 5QI sequence such as 5QI 10→5QI 3→5QI 1). For example, each application may be identified by a PSID/ITS-AID. For example, a first PSID/ITS-AID may be associated with a first 5QI sequence, a second PSID/ITS-AID may be associated with a second 5QI sequence, and so on. In some examples, multiple applications may use the same PSID/ITS-AID.

In some aspects of the disclosure, the previously described set of indications provided by the V2X AS layer 606 to the V2X NAS layer 604 may include on one or more types of information (e.g., metrics). For example, and as discussed in detail herein, the one or more types of information may include data transmission and/or reception statistics for the scheduled entity (e.g., scheduled entity 500), negative acknowledgments (NACKs) received at the scheduled entity for multicast or unicast transmissions from the scheduled entity, cyclic redundancy check (CRC) statistics for transmissions received at the scheduling entity, buffer status information at the scheduled entity, the status of each 5QI component, or combinations thereof.

In some aspects of the disclosure, the data transmission and/or reception statistics may be information that indicates a congestion level in the direct link (e.g., the PC5 link), such as a channel busy ratio (CBR) value. With respect to the NACKs received at the scheduled entity for multicast transmissions from the scheduled entity, if some of the intended receivers of the multicast transmissions are not able to receive data packets properly, the receivers may send a NACK to the transmitter. It should be understood that a potential receiver of a multicast transmission from the scheduled entity may be aware of scheduling information indicating when a transmission from the scheduled entity will be made. Such scheduling information may be transmitted over a reliable channel, but which is not suitable for data transmissions (e.g., due to a low coding rate of the channel). Accordingly, when a receiver expecting a data transmission cannot obtain one or more data packets, the receiver may respond to the transmitting scheduled entity with an NACK.

CRC statistics may be maintained at the scheduled entity, which may indicate the number of packets correctly received at the scheduling entity and/or the number of packets incorrectly received at the scheduling entity with respect to a set number of received transmissions. Since the scheduling entity may use the same direct link (e.g., the PC5 link) for transmission and reception purposes, the scheduling entity may detect that the direct link is performing too poorly (e.g., due to congestion) for a data transmission based on the CRC statistics.

In some aspects of the disclosure, the buffer status information at the scheduled entity may include one or more buffer sizes and/or one or more buffer delays. In some aspects of the disclosure, the V2X AS layer 606 may select resources for a transmission according to the current channel conditions. Therefore, in scenarios where the V2X AS layer 606 attempts to transmit data over a busy channel (e.g., in the PC5 link), the transmission may not be immediately performed. In such scenarios, the buffer size and buffer delay at the scheduled entity may increase. This information (e.g., the increased buffer size and/or buffer delay) may be provided to the V2X NAS layer 604 to help trigger a downgrade of the QoS level in order to improve performance. In some aspects of the disclosure, the V2X NAS layer 604 may modify the delay bound in scenarios where data packets have been stored in the buffer a threshold period of time.

With respect to the status of each 5QI component, the V2X AS layer 606 may indicate to the V2X NAS layer 604 that one or more 5QI components, such as a PDB, an error rate, and/or a burst size, cannot be met. Such information may help the V2X NAS layer 604 to decide how to step down the requested QoS level. In some aspects of the disclosure, the V2X NAS layer 604 may receive feedback for every individual 5QI component from the V2X AS layer 606. For example, the V2X AS layer 606 may indicate that the required error rate value may be met, but the required PDB may be exceeded.

In some aspects of the disclosure, one or more logical channels may be used at the V2X AS layer 606 and the QoS statistics may be associated with the logical channels. For example, the V2X AS layer 606 may indicate to the V2X NAS layer 604 that 5QI 7 will be using logical channel 7.

In some aspects of the disclosure, a scheduled entity may be configured with a set of thresholds for the previously discussed one or more types of information (e.g., the data transmission and/or reception statistics at the scheduled entity, the NACKs received at the scheduled entity for multicast transmissions from the scheduled entity, the CRC statistics for transmissions received at the scheduling entity, the buffer status information at the scheduled entity, and/or the status of each 5QI component). In some examples, the V2X NAS layer 604 may use such thresholds to trigger modification (e.g., upgrade or downgrade) of the QoS level requested by an application.

In some aspects of the disclosure, the scheduled entity may be configured to obtain a QoS status indicator value based on the previously discussed one or more types of information (e.g., the data transmission and/or reception statistics at the scheduled entity, the NACKs received at the scheduled entity for multicast transmissions from the scheduled entity, the CRC statistics for transmissions received at the scheduling entity, the buffer status information at the scheduled entity, and/or the status of each 5QI component). For example, the QoS status indicator value may represent a relative amount of congestion in the direct link (e.g., in the PC5 link). In one aspect of the disclosure, the QoS status indicator value may be based on a weighted average of the one or more types of information. In some examples, the scheduled entity may obtain the QoS status indicator value by calculating a weighted average of the one or more types of information. The weights to be applied to the one or more types of information may be preconfigured at the scheduled entity or configured by a network. In one example implementation, the V2X NAS layer 604 may determine whether the obtained QoS status indicator value exceeds a threshold value. If the threshold value is exceeded (e.g., indicating congestion in the direct link), the V2X NAS layer 604 may modify (e.g., downgrade) the QoS level indicated by an application using the approaches described herein. In some aspects of the disclosure, multiple threshold values for the QoS status indicator value may be configured at the scheduled entity. The V2X NAS layer 604 may modify the QoS level requested by an application based on a QoS level modification scheme associated with any of the exceeded threshold values.

In some aspects of the disclosure, the scheduled entity (e.g., the scheduled entity 500) may transmit data to a receiving scheduled entity over a direct wireless communication link (e.g., the PC5 link). The receiving scheduled entity may detect a QoS level based on the data transmission from the scheduled entity and may provide feedback regarding the QoS level to the scheduled entity. In one aspect of the disclosure, the scheduling entity may determine whether to modify the QoS level requested by an application based on the QoS level provided by the receiving scheduled entity.

Any of the approaches for modifying the QoS level requested by an application described herein may be implemented using Mode 3. For example, when Mode 3 is used, the scheduled entity may report the previously described one or more types of information (e.g., metrics) to the scheduling entity. In some aspects of the disclosure, the scheduled entity may transmit such report when a reporting event (e.g., based on a reporting configuration provided by the scheduling entity) is satisfied. Depending on the reported information, the scheduling entity may modify (e.g., upgrade or downgrade) the QoS level requested by an application of the scheduled entity. For example, the scheduling entity may change the QoS level requested by an application of the scheduled entity to another QoS level that is within a range of QoS levels provided by the scheduled entity. For example, the scheduled entity may provide such range of QoS levels to the scheduling entity in a sidelink information message.

FIG. 7 is a flow chart illustrating an exemplary process 700 in accordance with some aspects of the present disclosure. As described below, some or all illustrated features may be omitted in a particular implementation within the scope of the present disclosure, and some illustrated features may not be required for implementation of all embodiments. In some examples, the process 700 may be carried out by a first device (e.g., the scheduled entity 500 illustrated in FIG. 5). In some examples, the process 900 may be carried out by any suitable apparatus or means for carrying out the functions or algorithm described below. It should be understood that the operations indicated with dashed lines represent optional operations.

At block 702, the first device obtains a range of suitable QoS levels from one or more sources. In some aspects of the disclosure, the range of suitable QoS levels may include a set of upper and lower QoS level bounds, a set or list of QoS levels, and/or a sequence of QoS levels. In some aspects of the disclosure, the one or more sources may include at least the application (e.g., the application running on the first device) or a network control function. In some aspects of the disclosure, the first device obtains the range of suitable QoS levels by receiving the range of suitable QoS levels from one or more sources via radio resource control (RRC) signaling, provisioning signaling based on an Open Mobile Alliance Device Management (OMA DM) protocol, or provisioning signaling via a NAS in a policy framework of the network.

At block 704, the first device operates a timer configured to measure a sequence of set time intervals.

At block 706, the first device determines to modify a first QoS level for a data transmission from the first device to a second device, wherein the first device is configured to communicate with the second device through a direct wireless communication link, and wherein the first QoS level is requested by an application of the first device. In an aspect, the determination to modify the first QoS level and the modification of the first QoS level to the second QoS level are performed for each of the set time intervals. In an aspect, the determining to modify the first QoS level for the data transmission includes obtaining a set of indications from a V2X AS layer, wherein the set of indications includes at least data transmission and/or reception statistics for the first device, NACKs received at the first device for multicast transmissions from the first device, CRC statistics for transmissions received at the first device, buffer status information at the first device, or a status of each 5QI component, and determining that one or more of the set of indications exceeds at least one threshold. In some aspects, the determination to modify the first QoS level for the data transmission includes obtaining a set of indications from V2X AS layer, wherein the set of indications includes at least data transmission and/or reception statistics for the first device, NACKs received at the first device for multicast transmissions from the first device, CRC statistics for transmissions received at the first device, buffer status information at the first device, or a status of each 5QI component, determining a QoS status indicator based on the set of indications, and determining that the QoS status indicator exceeds at least one threshold. In an aspect, the determining the QoS status indicator includes determining a weighted average of the set of indications. In an aspect, the data transmission is a V2X data transmission stream. In an aspect, the determination to modify the first QoS level and the modifying the first QoS level to the second QoS level are performed for each of the set time intervals.

At block 708, the first device modifies the first QoS level to a second QoS level, wherein the direct wireless communication link is able to support the second QoS level and is unable to support the first QoS level. In an aspect, the modification of the first QoS level to the second QoS level includes selecting the second QoS level from the range of suitable QoS levels. In an aspect, the range of suitable QoS levels is configured to enable a gradual increase or decrease of one or more QoS parameters.

At block 710, the first device transmits the data transmission based on the second QoS level.

FIG. 8 is a flow chart illustrating an exemplary process 800 in accordance with some aspects of the present disclosure. As described below, some or all illustrated features may be omitted in a particular implementation within the scope of the present disclosure, and some illustrated features may not be required for implementation of all embodiments. In some examples, the process 800 may be carried out by a first device (e.g., the scheduled entity 500 illustrated in FIG. 5). In some examples, the process 800 may be carried out by any suitable apparatus or means for carrying out the functions or algorithm described below. It should be understood that the operations indicated with dashed lines represent optional operations.

At block 802, the first device transmits a set of indications from a vehicle-to-everything (V2X) access stratum (AS) layer to a network (e.g., a scheduling entity, such as the scheduling entity 400 in FIG. 4). In an aspect, the set of indications includes at least data transmission and/or reception statistics for the device, NACKs received at the device for multicast transmissions from the device, CRC statistics for transmissions received at the device, buffer status information at the device, or a status of each 5QI component.

At block 804, the first device obtains an indication from the network to modify a first QoS level for a data transmission from the first device to a second device, wherein the first device is configured to communicate with the second device through a direct wireless communication link, and wherein the direct wireless communication link is able to support the second QoS level and is unable to support the first QoS level.

At block 806, the first device modifies the first QoS level to the second QoS level.

At block 808, the first device transmits the data transmission based on the second QoS level.

In one configuration, the apparatus 500 for wireless communication includes means for determining to modify a first QoS level for a data transmission from the scheduled entity 500 (also referred to as a first scheduled entity or a first device) to a second scheduled entity (also referred to as a second device), means for obtaining a range of suitable QoS levels from one or more sources, means for obtaining an indication from the network to modify a first QoS level for a data transmission from the scheduled entity 500 to the second scheduled entity, means for modifying the first QoS level to a second QoS level, means for transmitting the data transmission based on the second QoS level, means for operating a timer configured to measure a sequence of set time intervals, and/or means for transmitting a set of indications from a V2X AS layer to a network. In one aspect, the aforementioned means may be the processor 504 shown in FIG. 5 configured to perform the functions recited by the aforementioned means. In another aspect, the aforementioned means may be a circuit or any apparatus configured to perform the functions recited by the aforementioned means.

Of course, in the above examples, the circuitry included in the processor 504 is merely provided as an example, and other means for carrying out the described functions may be included within various aspects of the present disclosure, including but not limited to the instructions stored in the computer-readable storage medium 506, or any other suitable apparatus or means described in any one of the FIGS. 1 and/or 2, and utilizing, for example, the processes and/or algorithms described herein in relation to FIGS. 7 and/or 8.

In one or more examples, the computer-readable storage medium 506 may include QoS level determining software 560 configured for various functions, including, for example, determining to modify a first QoS level for a data transmission from the scheduled entity 500 (also referred to as a first scheduled entity or a first device) to a second scheduled entity (also referred to as a second device), obtaining a range of suitable QoS levels from one or more sources, and/or obtaining an indication from the network to modify a first QoS level for a data transmission from the scheduled entity 500 to the second scheduled entity. For example, the scheduled entity 500 may be configured to communicate with the second scheduled entity through a direct wireless communication link (e.g., a PC5 link), and the first QoS level may be requested by an application of the scheduled entity 500. For example, the QoS level determining software 560 may be configured to implement one or more of the functions described herein in relation to FIGS. 7 and 8, including, e.g., blocks 702, 706, 804.

In some aspects of the disclosure, the computer-readable storage medium 506 may include QoS level modifying software 562 configured for various functions, including, for example, modifying the first QoS level to a second QoS level. For example, the QoS level modifying software 562 may be configured to implement one or more of the functions described herein in relation to FIGS. 7 and 8, including, e.g., blocks 708, 806.

In some aspects of the disclosure, the computer-readable storage medium 506 may include data transmitting software 564 configured for various functions, including, for example, transmitting the data transmission based on the second QoS level. For example, the data transmitting software 564 may be configured to implement one or more of the functions described herein in relation to FIGS. 7 and 8, including, e.g., blocks 710, 808.

In some aspects of the disclosure, the computer-readable storage medium 506 may include timer operating software 566 configured for various functions, including, for example, operating a timer configured to measure a sequence of set time intervals. For example, the timer operating software 566 may be configured to implement one or more of the functions described herein in relation to FIG. 7, including, e.g., block 704.

In some aspects of the disclosure, the computer-readable storage medium 506 may include indication transmitting software 568 configured for various functions, including, for example, transmitting a set of indications from a V2X AS layer to a network. For example, the indication transmitting software 568 may be configured to implement one or more of the functions described herein in relation to FIG. 8, including, e.g., block 802.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-8 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-8 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method, comprising:
determining, at a first device, to modify a first quality of service (QoS) level for a data transmission from the first device to a second device, wherein the first device is configured to communicate with the second device through a direct wireless communication link, and wherein the first QoS level is requested by an application of the first device;
modifying, at the first device, the first QoS level to a second QoS level, wherein the direct wireless communication link is able to support the second QoS level and is unable to support the first QoS level; and
transmitting the data transmission based on the second QoS level.

2. The method of claim 1, further comprising:
operating a timer configured to measure a sequence of set time intervals,
wherein the determining to modify the first QoS level and the modifying the first QoS level to the second QoS level are performed for each of the set time intervals.

3. The method of claim 1, further comprising:
obtaining a range of suitable QoS levels from one or more sources, wherein the range of suitable QoS levels includes at least a set of upper and lower QoS level bounds, a set of QoS levels, or a sequence of QoS levels,
wherein the modifying the first QoS level to the second QoS level includes selecting the second QoS level from the range of suitable QoS levels.

4. The method of claim 3, wherein the range of suitable QoS levels is configured to enable a gradual increase or decrease of one or more QoS parameters.

5. The method of claim 3, wherein the one or more sources includes at least the application or a network control function.

6. The method of claim 3, wherein the obtaining the range of suitable QoS levels from the one or more sources comprises:
receiving, at the first device, the range of suitable QoS levels from the one or more sources via radio resource control (RRC) signaling, provisioning signaling based on an Open Mobile Alliance Device Management (OMA DM) protocol, or provisioning signaling via a non-access stratum (NAS) in a policy framework of a network.

7. The method of claim 1, wherein the determining to modify the first QoS level for the data transmission includes:
obtaining a set of indications from a vehicle-to-everything (V2X) access stratum (AS) layer, wherein the set of indications includes at least data transmission and/or reception statistics for the first device, negative acknowledgments (NACKs) received at the first device for multicast transmissions from the first device, cyclic redundancy check (CRC) statistics for transmissions received at the first device, buffer status information at the first device, or a status of each 5QI component; and
determining that one or more of the set of indications exceeds at least one threshold.

8. The method of claim 1, wherein the determining to modify the first QoS level for the data transmission includes:
obtaining a set of indications from a vehicle-to-everything (V2X) access stratum (AS) layer, wherein the set of indications includes at least data transmission and/or reception statistics for the first device, negative acknowledgments (NACKs) received at the first device for multicast transmissions from the first device, cyclic redundancy check (CRC) statistics for transmissions received at the first device, buffer status information at the first device, or a status of each 5QI component;
determining a QoS status indicator based on the set of indications; and
determining that the QoS status indicator exceeds at least one threshold.

9. The method of claim 8, wherein the determining the QoS status indicator includes determining a weighted average of the set of indications.

10. The method of claim 1, wherein the data transmission is a vehicle-to-everything (V2X) data transmission stream.

11. An apparatus for wireless communication, comprising:
a processor;
a transceiver communicatively coupled to the at least one processor; and
a memory communicatively coupled to the at least one processor,
wherein the processor is configured to:
determine, at the apparatus, to modify a first quality of service (QoS) level for a data transmission from the apparatus to a second apparatus, wherein the apparatus is configured to communicate with the second apparatus through a direct wireless communication link, and wherein the first QoS level is requested by an application of the apparatus;
modify, at the apparatus, the first QoS level to a second QoS level, wherein the direct wireless communication link is able to support the second QoS level and is unable to support the first QoS level; and
transmit the data transmission based on the second QoS level.

12. The apparatus of claim 11, wherein the processor is further configured to:
operate a timer configured to measure a sequence of set time intervals,
wherein the determination to modify the first QoS level and the modification of the first QoS level to the second QoS level are performed for each of the set time intervals.

13. The apparatus of claim 11, wherein the processor is further configured to:
obtain a range of suitable QoS levels from one or more sources, wherein the range of suitable QoS levels includes at least a set of upper and lower QoS level bounds, a set of QoS levels, or a sequence of QoS levels,
wherein the modification of the first QoS level to the second QoS level includes selecting the second QoS level from the range of suitable QoS levels.

14. The apparatus of claim 13, wherein the range of suitable QoS levels are configured to enable a gradual increase or decrease of one or more QoS parameters.

15. The apparatus of claim 13, wherein the one or more sources includes at least the application or a network control function.

16. The apparatus of claim 13, wherein the processor configured to obtain the range of suitable QoS levels from the one or more sources is further configured to:
receive the range of suitable QoS levels from the one or more sources via radio resource control (RRC) signaling, provisioning signaling based on an Open Mobile Alliance Device Management (OMA DM) protocol, or provisioning signaling via a non-access stratum (NAS) in a policy framework of a network.

17. The apparatus of claim 11, wherein the processor configured to determine to modify the first QoS level for the data transmission is further configured to:
obtain a set of indications from a vehicle-to-everything (V2X) access stratum (AS) layer, wherein the set of indications includes at least data transmission and/or reception statistics for the first device, negative acknowledgments (NACKs) received at the first device for multicast transmissions from the first device, cyclic redundancy check (CRC) statistics for transmissions received at the first device, buffer status information at the first device, or a status of each 5QI component; and
determine that one or more of the set of indications exceeds at least one threshold.

18. The apparatus of claim 11, wherein the processor configured to determine to modify the first QoS level for the data transmission is further configured to:
obtain a set of indications from a vehicle-to-everything (V2X) access stratum (AS) layer, wherein the set of indications includes at least data transmission and/or reception statistics for the first device, negative acknowledgments (NACKs) received at the first device for multicast transmissions from the first device, cyclic redundancy check (CRC) statistics for transmissions received at the first device, buffer status information at the first device, or a status of each 5QI component;
determine a QoS status indicator based on the set of indications; and
determine that the QoS status indicator exceeds at least one threshold.

19. The apparatus of claim 18, wherein the processor configured to determine the QoS status indicator is further configured to:
determine a weighted average of the set of indications.

20. The apparatus of claim 11, wherein the data transmission is a vehicle-to-everything (V2X) data transmission stream.

21. A method, comprising:
transmitting, from a device, a set of indications from a vehicle-to-everything (V2X) access stratum (AS) layer to a network;
obtaining, at the device, an indication from the network to modify a first quality of service (QoS) level for a data transmission from the device to a second device, wherein the device is configured to communicate with the second device through a direct wireless communication link, and wherein the direct wireless communication link is able to support a second QoS level and is unable to support the first QoS level;
modifying, at the device, the first QoS level to the second QoS level; and
transmitting the data transmission based on the second QoS level.

22. The method of claim 21, wherein the set of indications includes at least data transmission and/or reception statistics for the device, negative acknowledgments (NACKs) received at the device for multicast transmissions from the device, cyclic redundancy check (CRC) statistics for transmissions received at the device, buffer status information at the device, or a status of each 5QI component.

23. An apparatus for wireless communication, comprising:
a processor;
a transceiver communicatively coupled to the at least one processor; and
a memory communicatively coupled to the at least one processor,
wherein the processor is configured to:
transmit, from the apparatus, a set of indications from a vehicle-to-everything (V2X) access stratum (AS) layer to a network;
obtain, at the apparatus, an indication from the network to modify a first quality of service (QoS) level for a data transmission from the apparatus to a second apparatus, wherein the first apparatus is configured to communicate with the second apparatus through a direct wireless communication link, and wherein the direct wireless communication link is able to support a second QoS level and is unable to support the first QoS level;
modify, at the apparatus, the first QoS level to the second QoS level; and
transmit the data transmission based on the second QoS level.

24. The apparatus of claim 23, wherein the set of indications includes at least data transmission and/or reception statistics for the device, negative acknowledgments (NACKs) received at the device for multicast transmissions from the device, cyclic redundancy check (CRC) statistics for transmissions received at the device, buffer status information at the device, or a status of each 5QI component.
